(19) United States
(12) Patent Application Publication
(10) Pub. No.: US 2023/0295936 A1
(43) Pub. Date: Sep. 21, 2023

(54) TRUCK-MOUNTED CONCRETE PUMP

(71) Applicant: SCHWING GMBH, Herne (DE)

(72) Inventors: Andreas Lehmann, Moers (DE); Uwe Krischan, Herne (DE); Karl-Heinz Schwedhelm, Castrop-Rauxel (DE); Johannes Henikl, Dorsten (DE); Roland Schink, Herne (DE); Reiner Vierkotten, Oberhausen (DE)

(21) Appl. No.: 18/021,106

(22) PCT Filed: Aug. 6, 2021
(86) PCT No.: PCT/EP2021/072030

§ 371 Date: Feb. 13, 2023

(30) Foreign Application Priority Data
Aug. 13, 2020 (DE) 10 2020 121 360.3

(51) Int. Cl. E04G 21/04; F04B 15/02; F04B 1/02; F04B 17/03; F04B 17/06; B60L 1/00; B60L 58/12; H02J 7/00

(52) U.S. Cl. CPC E04G 21/0436; F04B 15/02; F04B 1/02; F04B 17/03; F04B 17/06; B60L 1/003; B60L 58/12; H02J 7/007; B60L 2200/40; B60L 2240/545; E04G 21/0445

(57) ABSTRACT

A power supply unit includes inputs for receiving electric energy from multiple electric energy sources. The power supply unit also includes outputs for delivering electric energy for operating working components of a truck-mounted concrete pump. The power supply unit is configured to control consumption of electrical energy from the electric energy sources.

The invention relates to a truck-mounted concrete pump having an electric drive system with at least one electric drive configured to drive working components of the truck-mounted concrete pump, and a power supply unit with inputs and outputs for receiving electric energy from at least two electric energy sources and for delivering electric energy to the electric drive. Furthermore, the invention relates to a power supply unit for supplying electrical energy to an electrical drive for driving working components of a truck-mounted concrete pump.

In today's truck-mounted concrete pumps, the diesel engine of the travel drive of the truck on which the concrete pump is mounted is used on the construction site to drive the concrete pump components. The powerful diesel engine in combination with a sufficient tank capacity is completely sufficient for pumping operation today.

In the case of an at least partially electrically driven truck-mounted concrete pump, the problem is that the electrical power provided by an internal electrical energy storage, e.g. an accumulator and/or a construction site power supply, is generally insufficient to drive the truck-mounted concrete pump electrically for the concrete pumping process sufficiently or for a sufficiently long period of time.

In the future, it is expected that the diesel engine of the truck will no longer be usable for the traction drive and that the truck will be driven purely electrically. It is very unlikely that the accumulator provided for the truck's traction drive or even a fuel cell alone can provide sufficient capacity for the very power-intensive pumping operation of a truck-mounted concrete pump.

In the case of an electrically driven truck-mounted concrete pump, the problem is that the electrical power provided by an on-board battery and/or a construction site power supply is not sufficient to drive the truck-mounted concrete pump electrically for the concrete delivery process sufficiently or for a sufficiently long period of time.

It is therefore the object of the invention to drive the concrete pump superstructure independently of the truck drive, preferably electrically, and to provide the concrete pump superstructure with adequate electrical energy for pumping operation.

This object is solved by a truck-mounted concrete pump with the features of claim 1 as well as by a power supply unit for supplying an electric drive for driving working components of a truck-mounted concrete pump with electric energy according to claim 12.

In that the power supply unit is configured to control the intake of electrical energy from at least two energy sources, the power supply unit can ensure that the truck-mounted concrete pump is reliably supplied with electrical energy from the at least two energy sources. For example, if the capacity of an accumulator connected to the power supply unit as an energy source is no longer sufficient to operate the truck-mounted concrete pump, the power supply unit can switch to a second connected energy source, such as a construction site power supply. On the other hand, if the construction site power supply is at the load limit, for example due to high current consumption by other consumers on the construction site, the power supply unit can switch to another energy source, for example an accumulator. In addition, the power supply unit can also interconnect the at least two power sources, for example, in parallel, in particular in the event that there is a highpower requirement when starting up individual units of the truck-mounted concrete pump.

Advantageous embodiments and further developments of the invention result from the dependent claims. It should be noted that the features listed individually in the claims can also be combined with each other in any desired and technologically useful manner and thus show further embodiments of the invention.

According to an advantageous embodiment, the power supply unit is configured to take into account status data of at least one connected electrical energy source when controlling the consumption of electrical energy. The fact that the power supply unit takes into account status data of the connected energy sources enables the power supply unit to control the consumption of electrical energy sources in a more targeted manner.

According to an advantageous embodiment, the status data concern the type of the connected electrical energy source. The fact that the status data relate to the type of the connected energy source means that it can take into account the type of the connected energy source and thus distinguish, for example, between rechargeable and non-rechargeable energy sources.

According to an advantageous embodiment, at least one of the electrical energy sources connected to the power supply unit is a rechargeable energy source, for example an accumulator, and the status data relate to the maximum available electrical power and/or the state of charge and/or the temperature of the rechargeable energy source. The power supply unit can take this status data into account during control and, for example, reduce the consumption of electrical energy from an energy source that is threatening to overheat or whose state of charge is low.

According to an advantageous embodiment, at least one electrical energy source connected to the power supply unit is a mains power supply and the status data relate to the maximum available electrical energy of the mains power supply. Since the power supply unit knows the maximum available electrical power on the basis of the status data of the mains power supply, it can take this into account when controlling the power sources in order, for example, to prevent an overload protection device of the mains power supply from being activated.

According to an advantageous embodiment, at least one electrical energy source connected to the power supply unit is a fuel cell and the status data relate to the maximum available electrical power of the fuel cell and/or the remaining electrical capacity. By taking these status data into account, the power supply unit can, for example, reduce the load on the fuel cell if the electrical capacity of the fuel cell is no longer sufficient for prolonged operation at full load.

According to an advantageous embodiment, the power supply unit is configured to provide a connected rechargeable energy source, for example an accumulator, with electrical energy for charging by means of a further connected electrical energy source. This enables the power supply unit to recharge an accumulator, for example during a pumping pause in which little electrical energy is required for the pumping process, so that the accumulator can provide the electrical energy together with one or more energy sources for driving the truck-mounted concrete pump when there is a high demand for electricity.

According to an advantageous embodiment, the status data of the electrical energy sources are transmitted via the inputs and outputs of the power supply unit. By using the inputs and outputs of the power supply unit for the transmission of the status data, the status data can be transmitted in an easy way.

According to an advantageous embodiment, the status data of the electrical energy sources are transmitted to the power supply unit via data interfaces that are different from the inputs and outputs of the power supply unit. This allows the status data to be transmitted reliably and independently of the connection of the electrical energy sources to the power supply unit.

According to an advantageous embodiment, the electric drive provides the power supply unit with data about the electric power requirements of the working components, and the power supply unit takes the data about the electric power requirements into account when receiving electric energy from the electric energy sources. In particular, the power supply unit can also couple available connected energy sources early when considering future power requirements or, for example, by activating a connected fuel cell, ensure that no under-supply can occur to the electric drive of the truck-mounted concrete pump

Further features, details and advantages of the invention will be apparent from the following description and from the drawings, which show examples of embodiments of the invention. Corresponding objects or elements are provided with the same reference signs in all figures. Showing:

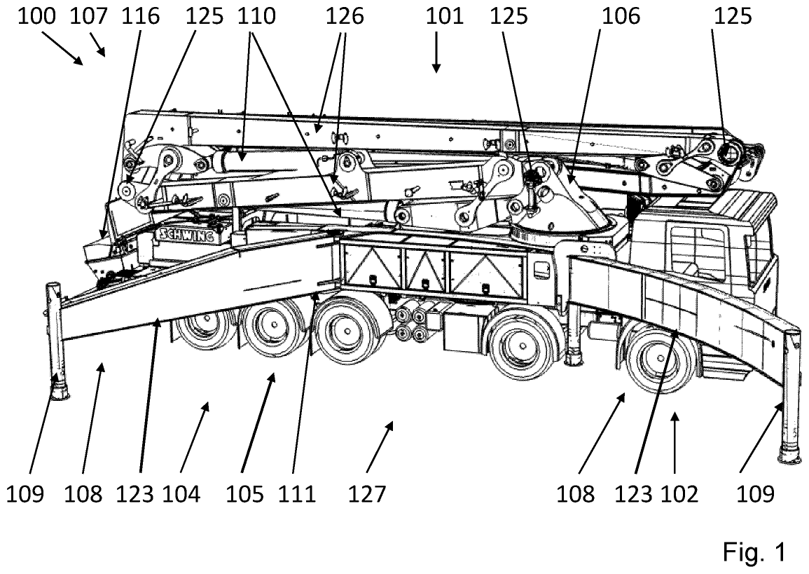

FIG. 1 View of a truck-mounted concrete pump according to the invention

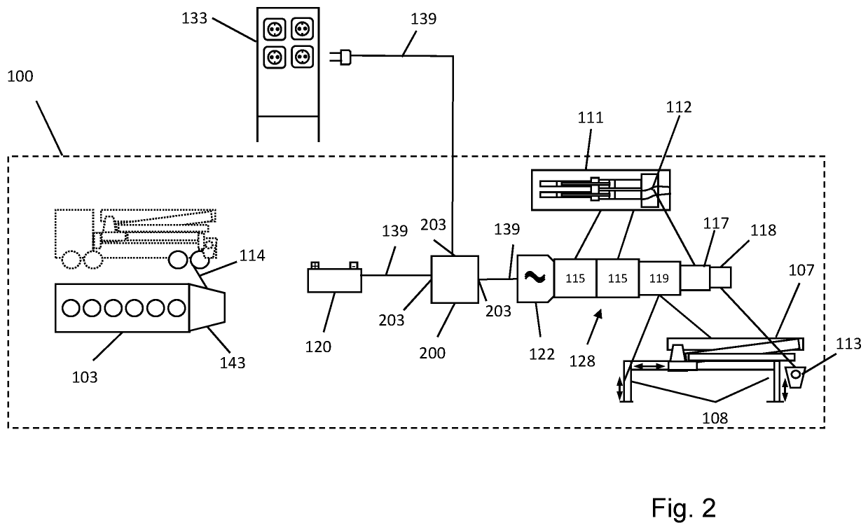

FIG. 2 Drive scheme of a truck-mounted concrete pump according to the invention in a first embodiment,

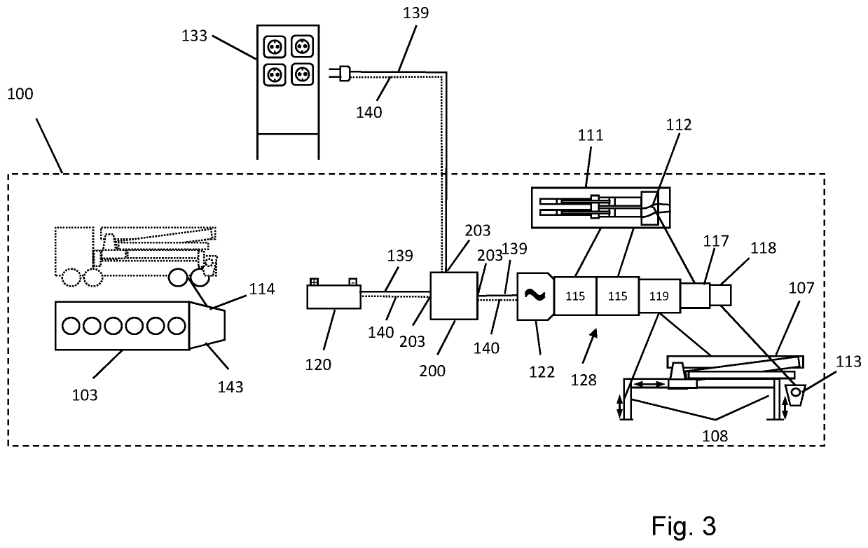

FIG. 3 Drive scheme of a truck-mounted concrete pump according to the invention in a second embodiment,

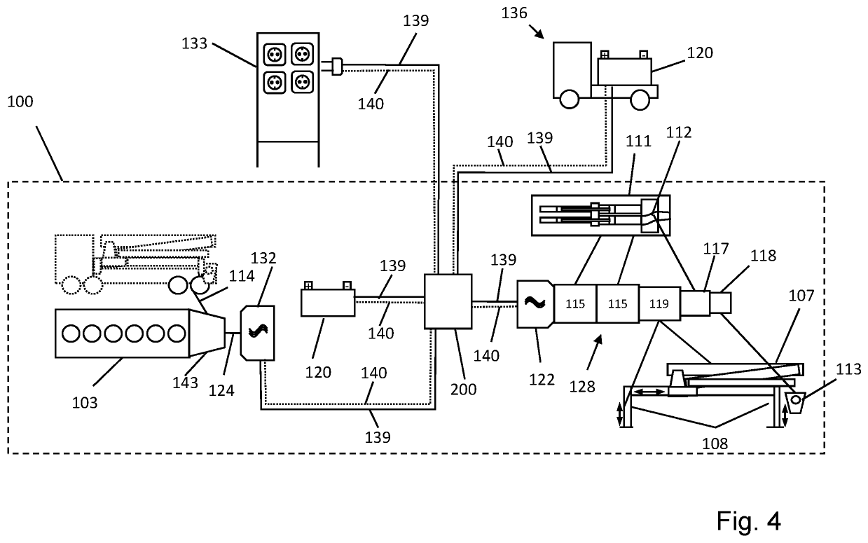

FIG. 4 Drive scheme of a truck-mounted concrete pump according to the invention in a third embodiment,

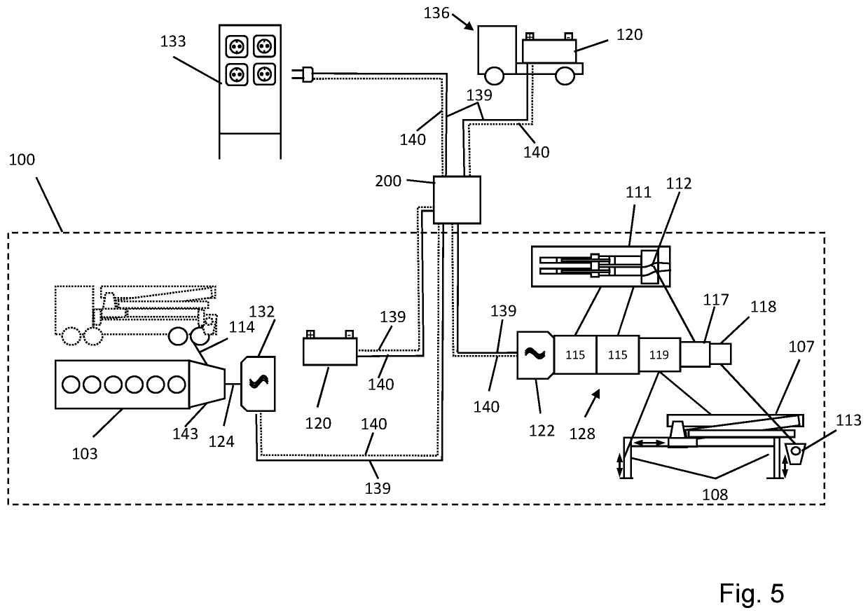

FIG. 5 Drive scheme of a truck-mounted concrete pump according to the invention in a fourth embodiment,

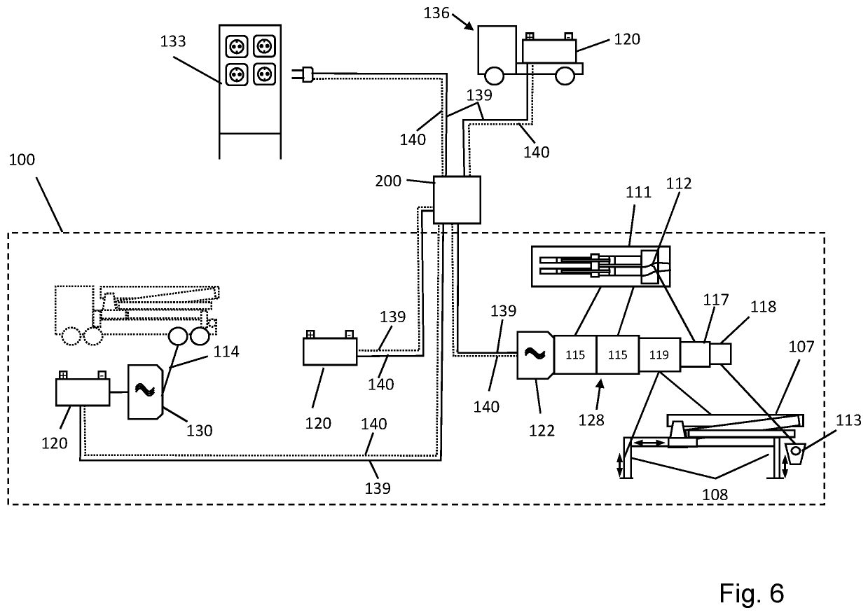

FIG. 6 Drive scheme of a truck-mounted concrete pump according to the invention in a fifth embodiment,

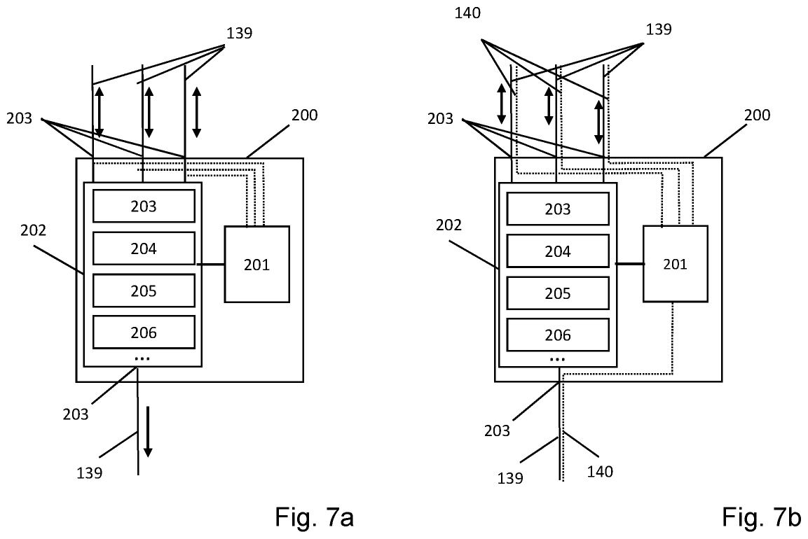

FIG. 7a Power supply unit according to the invention in a first embodiment,

FIG. 7b Power supply unit according to the invention in a second embodiment, and

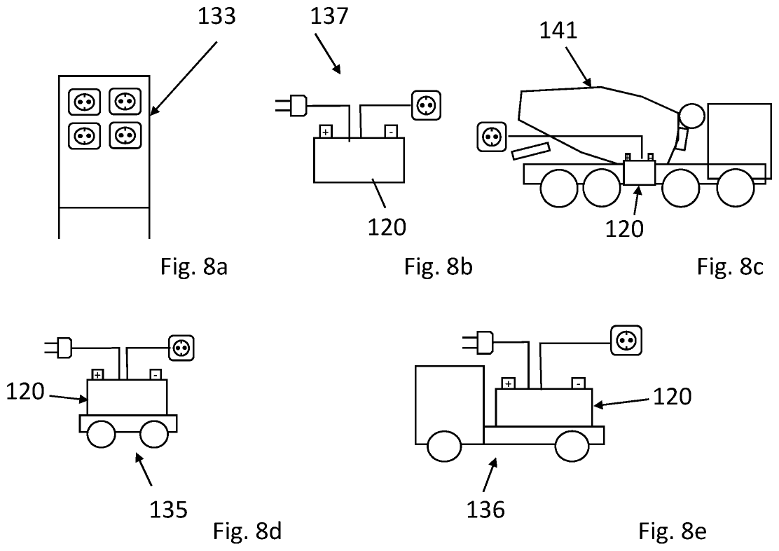

FIG. 8a-e Examples of electric energy sources.

A truck-mounted concrete pump according to the invention is shown in FIG. 1 with the reference sign 100. The truck-mounted concrete pump 100 has, in particular, a truck 102 driven by a combustion drive engine 103 (see FIGS. 3, 4, 5) or by an electric motor 130 (FIG. 6) and having a chassis 104 on which a concrete pump superstructure 101 is arranged. The concrete pump superstructure 101 substantially comprises a concrete pump substructure 127 having a support system 108 with hydraulically driven support cylinders 109 and foldable or extendable support struts 123, and a hydraulically driven concrete pump 111. At its rear end, the concrete pump substructure 127 carries a feed hopper 116 for liquid fresh concrete, in which an agitator 113 stirs the fresh concrete, which is fed in by a truck mixer, for example. A hydraulically driven pipe switch 112 (see FIG. 2) is arranged in the lower area of the feed hopper 116. The concrete pump substructure 127 also contains the hydraulic pumps 115, 119, 117 and 118 (see FIG. 2) for driving the units of the concrete pump superstructure 101. The concrete pump substructure 127 is connected via a turntable 106 to a distribution boom 107, the individual boom segments 126 of which are connected to one another via articulated joints 125. The distribution boom 107, or each of the articulated joints 125, is actuated by means of hydraulic cylinders 110. The hydraulic pressure for driving the hydraulic cylinders 110 of the distribution boom 107 and the support system 108 is provided by a hydraulic pump 119 (FIG. 2)

The concrete pump 111 is usually a two-cylinder piston pump (FIG. 2) with two hydraulically driven differential cylinders and two delivery cylinders, which alternately suck the fresh concrete from the feed hopper 116 and pump it via the pipe switch 112 into a not shown conveying pipe, which extends along the unfolded distribution boom 107, and thus distribute it on the construction site.

FIG. 2 shows a drive scheme of a truck-mounted concrete pump 100 according to the invention with a power supply unit 200 and an electric drive 122 in the form of an electric motor 122, which is configured to drive working components 107, 108, 113, 111, 112 of the truck-mounted concrete pump 100. The working components here are, for example, a distribution boom 107, a support system 108, a concrete pump 111, a pipe switch 112 and an agitator 113. For the sake of clarity, no further working components which may be present have been shown. In this embodiment, the working components 107, 108, 111, 112, 113 are driven by hydraulic pumps 115, 119, 117, 118 combined to form a hydraulic pump train 128. The hydraulic pump train 128 is driven by the electric motor 122. It would also be possible to drive individual working components 107, 108, 111, 112, directly, without the aid of hydraulics, with an electric motor, or to drive the hydraulic pumps 115, 117, 118, 119 individually with a plurality of electric motors 122.

The power supply unit 200 having inputs and outputs 203 is connected to receive electrical energy from at least two electrical energy sources 120, 133, in this case, for example, a rechargeable battery 120 and a construction site power supply 133. The electrical energy in the form of electric current is transmitted between the electrical energy sources 120, 133 and the power supply unit 200 via the power lines 139. The power supply unit 200 outputs the electrical energy, received from the electrical energy sources 120, 133, to the electrical drive in the form of an electric motor 122 via another power line 139. The power supply unit 200 is configured to control the intake of electrical energy from the at least two electrical energy sources 120, 132, 133. For example, the power supply unit 200 may reduce the current drawn from the connected accumulator 120 once the power supply unit 200 determines, for example based on received status data from the connected energy sources 120, 133, for example the output voltage of the accumulator 120, at the input/output 203 that the remaining capacity of the accumulator 120 is low. When the power demand of the working components 107, 108, 111, 112 is low, for example, during a pumping break, as determined by the power supply unit 200 based on the current power consumption of the electric motor 122, the power supply unit 200 may, for example, control the consumption of electrical energy from the electrical energy sources 120, 132, 133 so that energy is supplied from the construction site power supply 133 to the accumulator 120 to charge it. In this first embodiment, the terminal 203 of the power supply unit 200 to which the accumulator 120 is connected is also only suitable for connecting an accumulator, and the terminal 203 to which the construction site power supply 133 is connected is also only suitable for connecting a construction site power supply 133. For example, during the pumping operation that results in high energy consumption by the electric motor 122, the power supply unit 200 can connect both energy sources 120, 130 together and use, for example, pumping pauses in which little electrical energy is consumed to charge the accumulator 120 by means of the construction site power supply 133.

FIG. 3 shows a drive scheme of a truck-mounted concrete pump 100 with a power supply unit 200, in which data channels 140 for transmitting status data of the electrical energy sources 120, 132, 133 are shown in parallel with the power lines 139. The status data is, for example, the type of the connected electrical energy source 120, 132, 133. The information about the type of the electrical energy source 120, 132, 133 may be, in the simplest case, the information “Rechargeable” for an accumulator 120 and “Non-rechargeable” for a construction site power supply 133. For example, in the case of a construction site power supply 133, the type information could further include the indication “Unlimited capacity” and could, for example, deal with information about the maximum current output in amperes.

The data channels 140 may physically be the power lines 139 themselves, if as described above, for example, the status data concerns the output voltage of a connected accumulator 120, which the power supply unit 200 may measure at the power line 139 of the accumulator 120. On the other hand, the power line 139 can additionally be used as a data channel 140 by signaling the status data of the connected energy source, for example, in the form of power line technology, such as is known from home networks. In this case, both the connected energy source 120, 132, 133 and the power supply unit 200 must have corresponding powerline transmit/receive units, not shown, with which the status data are modulated onto the power line 139. The data channels 140 may also be radio channels with which the status data is transmitted between the energy sources 120, 132, 133 and the power supply unit 200 by radio (Bluetooth, WLAN or the like). Furthermore, the data channels may, for example, be separate electrical lines via which, for example, parallel or serial data bus signals (CAN-BUS or the like) are transmitted. Another data channel 140 between the power supply unit 200 and the electric motor 122 may be used to use power consumption data from the electric motor 122 in the power supply unit 200 to control the energy sources 120, 132, 133. This data line 140 is shown connected to the electric motor 122 in FIGS. 3, 4, 5, and 6, but could also be connected to a controller of the concrete pump assembly 101 or a controller of the electric motor 122 that provides status data for the power supply unit 200 about future power consumption. For example, the power supply unit 200 may receive early notification of the start of the pumping operation so that the power supply unit 200 may couple a plurality of electrical energy sources 120, 132, 133 prior to the start to then provide sufficient electrical energy for the pumping operation without overloading individual electrical energy sources 120, 132, 133.

FIG. 4 shows a variant of the invention in which the combustion drive engine 103 of the truck 102 drives a generator 132 via a power take-off (PTO) 124, which is connected to the power supply unit 200 via the power line 140. The generator 132 can be used, on the one hand, to charge the accumulator 120 of the concrete pump superstructure 101 via the power supply unit 200 while traveling to and from the construction site or, on the other hand, to be used as an additional or emergency power source during pumping operations at the construction site, for example, when the accumulator 120 of the concrete pump superstructure 101 is discharged and/or no construction site power supply 133 is available and/or the concrete pump superstructure 101 requires a very high electrical power for working operation. Furthermore, FIG. 4 shows an accumulator 120 on a van 136 that is connected to the power supply unit 200 and can additionally be used to drive the concrete pump superstructure 101 from the power supply unit 200. The accumulator 120 on the van 136 can also be charged by the power supply unit 200 by appropriate circuitry or can also provide power, for example, for charging the accumulator 120 of the concrete pump superstructure 101.

FIG. 5 shows basically the same drive scheme as FIG. 4, but here the power supply unit 200 is arranged outside the truck-mounted concrete pump 100. The power supply unit 200 can also be arranged together with the accumulator 120 on the van 136. Thus, the van 136 can be used particularly well as an escort vehicle to ensure the supply of electrical power to the truck-mounted concrete pump 100 at the construction site. In the example embodiment according to FIG. 5, in order to ensure that the generator 132 can also be used to charge the accumulator 120 of the concrete pump superstructure while traveling to and from the construction site, a second, smaller power supply unit 200 could be arranged on the concrete pump superstructure 101 in order to establish a connection between the accumulator 120 and the generator 132.

FIG. 6 shows a variant of the invention in which the truck 102 is driven by an electric motor 130. The electric motor 130 obtains its drive energy from a further accumulator 120 (drive battery). For example, if the truck-mounted concrete pump 100 has to travel only a short distance to and from the construction site, the accumulator 120 of the traction drive of the truck 102 can additionally be used to drive the concrete pump superstructure 101 via the power supply unit 200. On the other hand, the accumulator 120 of the truck traction drive can also be charged via the power supply unit 200 from other connected electrical energy sources, for example the accumulator 120 of the transporter 136 or the construction site power supply 133.

FIG. 7a shows a first variant of the power supply unit 200, which has inputs and outputs 203 for connecting electrical energy sources 120, 132, 133. The power supply unit 200 picks up status data of the electrical energy sources 120, 132, 133, as already described above, via the power lines 139. This status data is transmitted to the control unit 201 of the power supply unit 200 via the data channels 140. As already described above, in the simplest case, the status data may be the output voltage of a connected accumulator 120, which provides information about the state of charge. Based on the received status data, the control unit 201 controls a switching unit 202. The switching unit 202 has, for example, one or more AC/DC converters 204, for converting AC voltage to DC voltage, AC/AC converters 205 for changing the frequency and/or voltage of an AC voltage, DC/AC converters 206 for converting DC voltage to AC voltage, and DC/DC converters 207 for changing the voltage of a DC voltage. In the switching unit 202, the converters 204, 205, 206, 207 are appropriately interconnected to provide, for example, sufficient power to drive the concrete pump superstructure 101 or to provide, for example, electrical power to connected accumulators 120 for a charging process. The power supply unit 200 may further include energy meters for each of the inputs and outputs 203 to record power consumption or output, respectively, for energy billing purposes. The inputs and outputs 203 may be physically configured so that each is only suitable for connection to a particular type of electrical energy source 120, 132, 133 and may be at least partially wired accordingly in the switching unit 202. For example, an input/output 203 shown at the top left of the control unit 200 in FIG. 7a may be provided only as an input for connection to a construction site power supply 133. Another input/output 203, shown at the bottom of the power supply unit 200, is provided only as an output for driving the electric motor 122. In the event that the concrete pump superstructure 101 is driven by multiple electric motors 132, multiple inputs/outputs 203 are to be provided accordingly. Further inputs/outputs 203, to which accumulators 120 are connected, for example, are suitable for both receiving and delivering electrical energy as described above. The data channels 140 may be designed to be bidirectional or unidirectional. For example, it is generally sufficient for an accumulator 120 to transmit its status data to the power supply unit 200 via a unidirectional data channel 140. A fuel cell as a connected power source could be connected to the power supply unit 200 via a bidirectional data channel, so that the power supply unit 200 can activate the fuel cell before a high current consumption from the fuel cell is necessary. A bidirectional data channel 140 between the electric drive motor 122 and a control unit of the concrete pump superstructure 101, respectively, which is not shown, could be used to signal an expected high current consumption to the power supply unit 200, on the other hand, the power supply unit 200 can then inform the control unit of the concrete pump superstructure 101 which maximum electric energy is available for the operation of the concrete pump superstructure 101 at any given time.

FIG. 7 shows a variant of the power supply unit 200 in which the data channels 140 are arranged separately from the power lines 139, as already described for the first time in connection with FIG. 2. The power supply unit 200 can also comprise mixed forms of the examples according to FIGS. 7a and 7b, i.e. a power supply unit 200 can be suitable for tapping off status data via the power lines 139 and additionally has the option of receiving status data via separate data channels 140. It is essential that the power supply unit 200 ensures by means of the control unit 201 that the drive of the concrete pump superstructure 101 always has sufficient electrical energy from one or more electrical energy sources 120, 132, 133, depending on the operating state, and that the power supply unit 200, if necessary, interconnects the electrical energy sources 120, 132, 133 at times of low energy demand in such a way that, for example, accumulators 120 are recharged.

FIGS. 8a to 8e show further possible electrical energy sources 120, 132, 133. In addition to the construction site power supply 133 already described (FIG. 8a) and an accumulator 120 on a van (FIG. 8e), this can also be an accumulator 120 on a trailer 135, which the truck-mounted concrete pump may tow to the construction site independently (FIG. 8d), or an accumulator 120 on a truck mixer 141 (FIG. 8c), which virtually carries the electrical energy required for the pumping process with it.

Although only accumulators 120 have been described thus far in the description, it is understood that fuel cells are also suitable as electrical power sources and are encompassed by the invention. Likewise, generators set up on the construction site and driven by a combustion drive engine could be connected to the power supply unit 200 to ensure operation of the concrete pump superstructure 101.

### LIST OF REFERENCE NUMERALS

100 truck-mounted concrete pump
101 concrete pump superstructure
102 truck
103 truck combustion drive engine
104 truck chassis
105 truck frame
106 turntable
107 distribution boom
108 support system
109 support cylinder
110 articulated joint drive
111 concrete pump
112 pipe switch
113 agitator
114 cardan shaft
115 hydraulic pump concrete pump
116 feed hopper
117 hydraulic pump pipe switch
118 hydraulic pump agitator
119 hydraulic pump boom/support system
120 accumulator
122 electric motor concrete pump drive
123 support struts
124 power take-off (PTO)
125 articulated joint
126 boom segments
127 concrete pump substructure
128 hydraulic pump train
130 truck electric drive motor
132 generator
133 construction site (mains) power supply
134 generator
135 trailer with electrical energy storage
136 van with electrical energy storage
137 construction site energy source
139 power line
140 data line
141 truck mixer
142 generator
143 gearbox
200 power supply unit
201 control unit
202 switching unit
203 in-/outputs power supply unit
204 AC/DC-converter
205 AC/AC-converter
206 DC/AC-converter
207 DC/DC-converter

1-15. (canceled)

16. A truck-mounted concrete pump comprising:
an electric drive configured to drive working components of the truck-mounted concrete pump; and
a power supply unit including inputs for receiving electrical energy from multiple electrical energy sources and outputs for delivering electrical energy to the electrical drive, wherein the power supply unit is configured to control the intake of electrical energy from the electrical energy sources.

17. The truck-mounted concrete pump of claim 16, wherein the power supply unit is configured to control the intake of electrical energy from the electrical energy sources based, at least in part, on status data from the electrical energy sources connected to the inputs of the power supply unit.

18. The truck-mounted concrete pump of claim 17, wherein the status data comprises a type of the electrical energy sources connected to the respective inputs of the power supply unit.

19. The truck-mounted concrete pump of claim 17, wherein at least one of the electrical energy sources connected to the power supply unit is a rechargeable electrical energy source, and wherein the status data relate to a maximum available electrical power, a state of charge, and/or a temperature of the rechargeable electrical energy source.

20. The truck-mounted concrete pump of claim 16, wherein the power supply unit is configured to provide electrical energy for charging to a rechargeable electrical energy source via a further connected electrical energy source.

21. The truck-mounted concrete pump of claim 17, wherein at least one of the electric energy sources connected to the power supply unit is a main power supply, and wherein the status data relate to a maximum available electric power of the main power supply.

22. The truck-mounted concrete pump of claim 17, wherein at least one of the electrical energy sources connected to the power supply unit is a fuel cell, and wherein the status data is a maximum available electrical power of the fuel cell and/or a remaining electrical power capacity.

23. The truck-mounted concrete pump of claim 17, wherein the status data of the electrical energy sources are transmitted via the inputs and outputs of the power supply unit.

24. The truck-mounted concrete pump of claim 17, wherein the status data of the electrical energy sources are transmitted to the power supply unit via data interfaces that are different from the inputs and outputs of the power supply unit.

25. The truck-mounted concrete pump of claim 16, wherein the electric drive is configured to provide data on the electric power demand of the working components to the power supply unit, and the power supply unit is configured to control the intake of electrical energy from the electrical energy sources based, at least in part, on the data on the electric power demand.

26. A power supply unit for supplying an electric drive for driving working components of a truck-mounted concrete pump with electric energy, the power supply unit comprising:
inputs for receiving electric energy from multiple electric energy sources; and
outputs for delivering electric energy for operating working components of a truck-mounted concrete pump,
wherein the power supply unit is configured to control consumption of electrical energy from the electric energy sources.

27. The power supply unit of claim 26, wherein the power supply unit is configured to control the consumption of electrical energy from the electrical energy sources based, at least in part, on status data from at least one of the electrical energy sources.

28. The power supply unit of claim 27, wherein the status data relate to a type of the electrical energy sources connected to the power supply unit.

29. The power supply unit of claim 27, wherein at least one of the electrical energy sources connected to the power supply unit is a rechargeable electrical energy source, and wherein the status data relate to a maximum available electrical energy, a state of charge, and/or a temperature of the rechargeable electrical energy source.

30. The power supply unit of claim 29, wherein the power supply unit is configured to provide electrical energy for charging the rechargeable electrical energy source via a further connected electrical energy source.
